(19) United States
(12) Patent Application Publication
(10) Pub. No.: US 2009/0260479 A1
(43) Pub. Date: Oct. 22, 2009

(54) REDUCTION DRIVE GEAR FOR ALL TERRAIN VEHICLES

(76) Inventor: Daniel L. Turner, Humble, TX (US)

Correspondence Address: GREENBERG & LIEBERMAN, LLC, 2141 WISCONSIN AVE, N.W., SUITE C-2, WASHINGTON, DC, 20007, US

(21) Appl. No.: 12/426,803

(22) Filed: Apr. 20, 2009

Related U.S. Application Data
(60) Provisional application No. 61/046,242, filed on Apr. 18, 2008.

(51) Int. Cl. F16H 1/00

(52) U.S. Cl. 74/640

(57) ABSTRACT

A reduction drive gear for all-terrain vehicles (ATV) such as the HONDA RINCON™. The gear reduces the drive ratio, thereby increasing the load pulling capacity of the vehicle and providing for a lower-end torque. It is comprised of a carbon steel bar cut to a seventeen-tooth drive gear (as opposed to the original nineteen-tooth drive gear found in typical ATVs). The reduction drive gear enables the ATV to be more powerful while avoiding any modifications to the motor, thereby eliminating the creation of undesirable heat in the motor.

This is a non-provisional application claiming priority to provisional patent application No. 61/046,242 filed on Apr. 18, 2008.

### FIELD OF THE INVENTION

The present invention is an improved reduction drive gear for all-terrain vehicles (ATVs) comprising seventeen teeth in order to reduce the gear ratio and enable lower-end torque.

### BACKGROUND OF THE INVENTION

All-terrain vehicles (ATVs) were created in the 1970's for a variety of purposes, from leisure to agriculture and farming or forestry and construction. ATVs are impervious to water and dirt and obviously function well on virtually every kind of terrain. Typically they have four wheels and are meant for individual use. Some ATVs are equipped to carry small loads, but do not have a tremendous amount of load-carrying capacity or torque. There is a need for a way of enabling an all-terrain vehicle, such as the HONDA RINCON™, to have more low-end power and torque without having to modify the motor of the vehicle, which could lead to overheating.

Relevant art to the present invention includes several publications and patents. It is anticipated that the patents discussed do not incorporate all of the elements that make the present invention unique. Some of these prior applications are gear structures or transmissions intended for use with vehicles other than ATVs; and the existing art that is pertinent to the ATV is entirely different from the present invention.

Japanese Publication No. 02048233, filed by Hiroshi and published on 19 Feb. 1990 is a four-wheel drive vehicle, which optimizes distribution of weight of front and rear wheel vehicles. Japanese Publication No. 03020144 filed by Hisayasu and published on 29 Jan. 1991 is a geared transmission, which uses a reduction drive gear to improve the extent of fuel consumption. Japanese Publication No. 03088968 filed by Hideo and published on 15 Apr. 1991 is a mounting structure of internal combustion engines to reduce the overall length of the internal combustion engine. The above make no reference to ATVs, and unlike the present invention they do not attempt to give vehicles more low-end power and torque.

Japanese Publication No. 2000220720 filed by Michitaka and published on 8 Aug. 2000 is a shaft structure for continuously variable transmission to enable the gearshift when a vehicle is stopped with a clutch means for dividing the driving force. Japanese Publication No. 2001099277 filed by Shinji and published on 10 Apr. 2001 is a friction gear structure of transmission to reduce the generation of gear-tooth hammering noise. Japanese Publication No. 2002087089 filed by Kazuo and published on 26 Mar. 2002 is a transmission for 4-wheel drive vehicles that improve fuel consumption. Japanese Publication No. 2002161872 filed by Yasuhino et al. and published on 7 Jun. 2002 is a bearing structure of change gear to reduce vibration and noise during gear change. Unlike the present invention, the publications make no reference to ATVs.

U.S. Pat. 6,857,499 issued to Kawamoto et al. on 22 Feb. 2005 is a transmission and gear position detector for all-terrain vehicles. US Publication 2005/0126834 filed by Davies and published on 16 Jun. 2005 is an all-terrain vehicle power takeoff. US Publication 2002/0152838 issued to Miguchi et al. on Oct. 24, 2002, is a power transmission device of an all-terrain vehicle. Unlike the present invention, the aforementioned patents and publications do not encompass all of the qualities and objectives of the present invention. As explained in the following summary, the present invention improves upon the reduction drive gears in all-terrain vehicles, giving the vehicle more power and load-carrying capacity without having to make modifications to the motor.

### SUMMARY OF THE INVENTION

The present invention is an improved reduction drive gear for all-terrain vehicles (ATVs), specifically for HONDA RINCON TM ATVs. However, it should be noted that the present invention is not limited to this brand of ATV and is compatible with other like ATVs. The gear lowers the drive ratio and gives the ATV a lower-end torque. A lower-end torque enables the vehicle to pull heavier loads and run oversize tires. Oversize tires give the bike more ground clearance. Normally oversize tires change the gear ratio to a higher gearing. The present invention lowers the gear ratio for oversize tires. Lowering the gear ratio also gives the vehicle more low-end power without having to do motor modifications, which is undesirable because it creates more heat in the engine, possibly leading to damage. The present invention is therefore an efficient remedy to provide more power and torque to the ATV without having to alter the motor. ATVs used at construction sites, for farming or forestry, would therefore maintain the dexterity of the vehicle because of its small size, while enabling the user to pull heavier loads.

### BRIEF DESCRIPTION OF THE DRAWINGS

FIG. 1 is the preferred embodiment of the present invention.

FIG. 2 is a side view of the present invention.

### DETAILED DESCRIPTION OF THE PRESENT EMBODIMENT

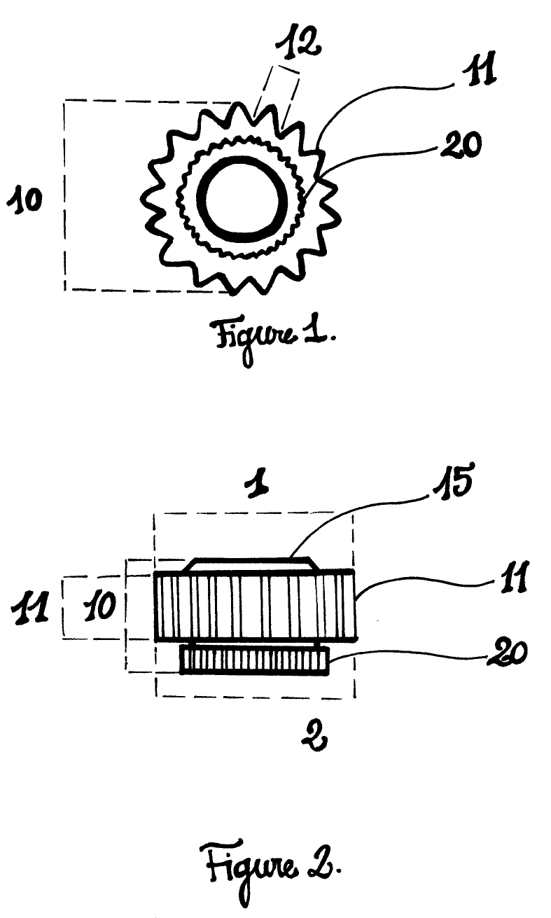

The present invention is a drive gear with seventeen teeth, which reduces the gear ratio from 2.00 to 2.24 gear ratio. Previously, in typical ATVs such as, but not limited to, the original HONDA RINCON™, the drive gear was comprised of nineteen teeth. As shown in FIG. 1, a reduction drive gear 10 as embodied in the present invention—with only seventeen teeth 11—lowers the gear ratio, enabling lower-end torque. The ATV would then be able to pull heavier loads, have the capacity to use oversize tires, and provide low-end power, without having to modify the motor. Having seventeen teeth 11 creates the best all-around ride, not filling to low geared, but just right.

Preferably the drive gear 10 is made out of 8620 hot-rolled carbon steel. It takes a certain degree of temperature to get the hardness of the steel to the number desired, and carbon steel is the conventional material of most gears. What makes this invention particularly unique is the number of teeth and the resulting lower-end torque without motor modifications. The bar is machined down to 2.062 thousandths for the outside diameter. The bar is then cut to 1.300 thousands in length in inches. It should be noted that all measurements are in inches. Once it is cut, the gear 10 is machined to an overall length of 1.240 thousandths. As for the seventeen teeth 11 of the gear 10, the height of an individual tooth 12 is 0.195 thousandths; base width is 235 thousandths; and top width is 0.733 thousandths, preferably. The front side 1 of the gear 10 is recessed through a lip 15 at 3.080 thousandths, with the outside diameter of 1.252 thousandths. The recessed lip is in place for clearance reasons. The backside 2 of the gear is splined to thirty-one teeth 20. The thirty-one tooth spline connects to the transmission shaft. The bottom width of the spline 20 is 0.93 thousandths, and the width of the spline 20 is 0.200 thousandths. The resulting gear gives the motor 16% more torque to the front and rear differentials.

Having illustrated the present invention, it should be understood that various adjustments and versions might be implemented without venturing away from the essence of the present invention. The present invention is not limited to the embodiments described above.

I claim:

1. A gear system, comprising:
a drive gear having seventeen (17) teeth;
a bar that is machined down to 2.062 thousandths for an outside diameter;
said drive gear machined to an overall length of 1.240 thousandths after said bar is cut to 1.300 thousands in length;
said seventeen (17) teeth being such that each individual tooth of said seventeen (17) teeth is 0.195 thousandths in height;
said seventeen (17) teeth being such that each said individual tooth of said seventeen (17) teeth is 235 thousandths in width;
said seventeen (17) teeth being such that each said individual tooth of said seventeen (17) teeth is 0.733 thousandths in top width;
said drive gear having a front side, said front side being recessed through a lip at 3.080 thousandths with an outside diameter of 1.252 thousandths;
said drive gear having a backside, said backside having a spline with thirty-one (31) teeth;
said spline in communication with a transmission shaft;
said spline having a bottom width of 0.93 thousandths; and
said spline having a width of 0.200 thousandths.

2. The drive gear system of claim 1, wherein said drive gear being made out of 8620 hot-rolled carbon steel.
